(19) United States
(12) Patent Application Publication
(10) Pub. No.: US 2013/0171285 A1
(43) Pub. Date: Jul. 4, 2013

(54) MOLDING SYSTEM

(71) Applicants: MING-WEI HONG, Tu-Cheng (TW); CHIEN-MING CHANG, Tu-Cheng (TW)

(72) Inventors: MING-WEI HONG, Tu-Cheng (TW); CHIEN-MING CHANG, Tu-Cheng (TW)

(73) Assignee: HON HAI PRECISION INDUSTRY CO., LTD., Tu-Cheng (TW)

(21) Appl. No.: 13/616,172

(22) Filed: Sep. 14, 2012

(30) Foreign Application Priority Data
Dec. 28, 2011 (CN) 201110446541.3

(51) Int. Cl. B28B 15/00

(52) U.S. Cl. 425/88

(57) ABSTRACT

A molding system includes a container, a plurality of molding machines positioned adjacent to the container, and a feeding module and a power supply module positioned within the container. The feeding module includes a main feeding pipe, a plurality of dehumidifiers connected to the main feeding pipe, and a plurality of branch feeding pipes connecting the dehumidifiers to the molding machines. The power supply module includes a power distribution box connected to the molding machines and the dehumidifiers. The container is divided into receiving boxes, in which a portion of the main air pipe and a portion of the main water pipe, one power distribution box, and several dehumidifiers are housing within each receiving box.

### BACKGROUND

1. Technical Field

The present disclosure generally relates to molding systems, and particularly, to a molding system having a container integrating a feeding module, a power supply module, and a water supply module.

2. Description of the Related Art

A product machining process, such as a machining process of the electronic device housing, is generally divided into steps such as molding and painting. Therefore, the workshops of a manufacturing factory are designed as dedicated molding workshops and dedicated painting workshops. The molding workshop has a plurality of molding machines, a feeding box for providing plastic materials to the molding machines, a plurality of dehumidifiers for drying the plastic materials, a plurality of electrical wires, a plurality of water pipes, and a plurality of air pipes. In use, the molding workshop needs a plurality of operators that drive transport vehicles to transport the plastic materials to fill the feeding box, and thus the labor cost is relatively high. In addition, when relocating the molding workshop, the molding machines, the feeding box, the dehumidifiers, the electrical wires, the water pipes, and the air pipes are firstly separated from each other, and are then all transported to a new molding workshop and reassembled in the new molding workshop. Accordingly, a lot of time is wasted in separating and reassembling the molding machines, the feeding box, the dehumidifiers, the electrical wires, the water pipes, and the air pipes.

Therefore, there is room for improvement within the art.

### BRIEF DESCRIPTION OF THE DRAWING

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an isometric view of an embodiment of a molding system.

FIG. 2 is a side view of the molding system of FIG. 1.

FIG. 3 is a schematic view of an inner side of a container of the molding system of FIG. 1.

### DETAILED DESCRIPTION

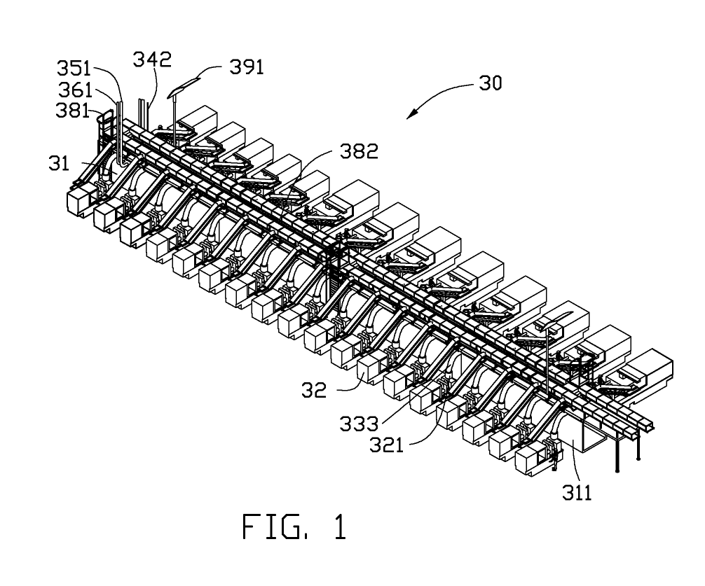

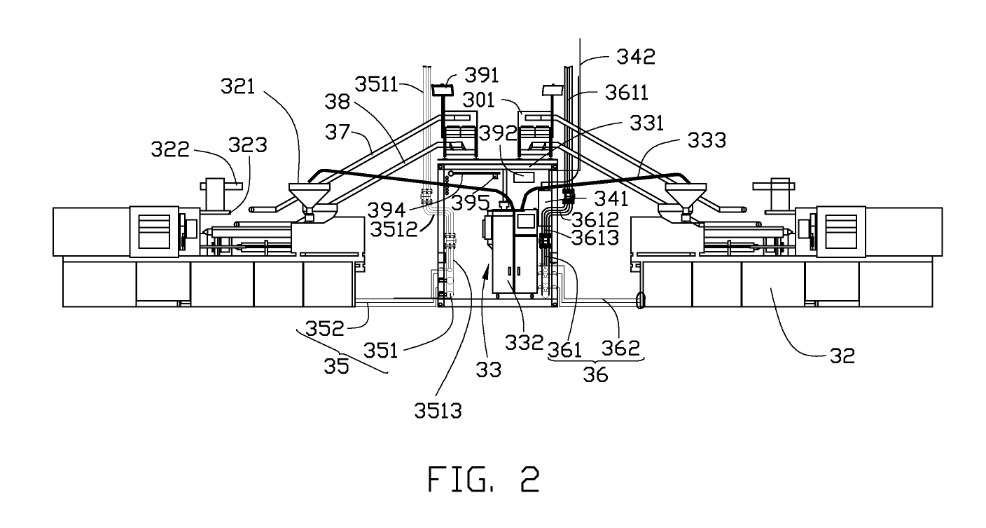

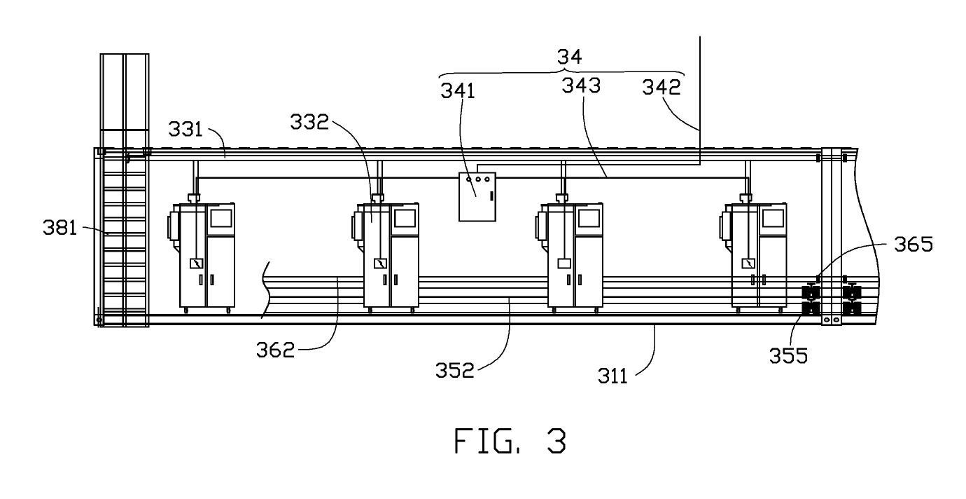

Referring to FIGS. 1 through 3, an embodiment of a molding system 30 includes a container 31, a plurality of molding machine 32 adjacent to the container 31, and a feeding module 33, a power supply module 34, a water supply module 35, and an air supply module 36 positioned in the container 31. In the illustrated embodiment, the plurality of molding machines 32 are positioned on opposite sides of the container 31 and arranged in two symmetrical rows. Each molding machine 32 forms a feeding hopper 321, a first discharge port 322, and a second discharge port 323. The container 31 includes a plurality of receiving boxes 311 detachably connected to each other.

The feeding module 33 includes a main feeding pipe 331 on a top of the container 31, a plurality of dehumidifiers 332 connected to the feeding pipe 331, and a plurality of branch feeding pipes 333 connecting the dehumidifiers 332 to the molding machines 32. In the illustrated embodiment, four dehumidifiers 332 are evenly arranged in each receiving box 311, and each dehumidifier 332 supports two branch feeding pipes 333 opposite to each other. The branch feeding pipes 333 are connected to the feeding hoppers 321 of the molding machines 32. The main feeding pipe 331 is connected to a feeding box (not shown) outside of the container 31 for transporting plastic materials to the dehumidifiers 332.

The power supply module 34 includes a power distribution box 341, an input power bus 342 connected to the power distribution box 341, and a plurality of electrical wires 343 connecting the power distribution box 341 to the molding machines 32 and the dehumidifier 332.

The water supply module 35 includes a main water pipe 351 and a plurality of branch water pipes 352 connected to the main water pipe 351. The main water pipe 351 includes a first section 3511 positioned outside of the receiving box 311, a second section 3512 extending through a side wall of the receiving box 311, and a third section 3513 positioned in the receiving box 311 and connected to the branch water pipes 352. The branch water pipes 352 are connected to the molding machines 32 for providing water to the molding machines 32. The water supply module 35 further includes a plurality of water valves 355 positioned at the branch water pipes 352.

The air supply module 36 includes a main air pipe 361 and a plurality of branch air pipes 362 connected to the main air pipe 361. The main air pipe 361 includes a first section 3611 positioned outside of the receiving box 311, a second section 3612 extending through the side wall of the receiving box 311, and a third section 3613 positioned in the receiving box 311 and connected to the branch air pipes 362. The branch air pipes 362 are connected to the molding machines 32 for providing compressed air to the molding machines 32. The air supply module 36 further includes a plurality of air valves 365 positioned at the branch air pipes 362.

The molding system 30 further includes two product conveyor lines 37 corresponding to the first discharge ports 322, and a scrap conveyor line 38 corresponding to the second discharge ports 323. The product conveyor line 37 transports the products produced by the molding machines 32 to a next processing system, such as a painting system. The scrap conveyor line 38 is used to conveying or transport recycle scrap from the molding machines 32. An anti-dust cover 301 is positioned over the product conveyor line 37.

The molding system 30 further includes an access ladder 381 positioned on an end of the container 31, and a passageway 382 formed in between the product conveyor lines 37. An operator (not shown) can climb to the top of the container 31 by using the access ladder 381, and then walk along the passageway 382 to check on the processing status of the products.

The molding system 30 further includes a first light source 392 positioned in the container 31, and a second light source 391 positioned on the top of the container 31. In the illustrated embodiment, the first light source 391 and the second light source 392 are light emitting diode (LED) light sources.

The molding system 30 further includes a fire sprinkler pipe 394 and a plurality of sprinkler nozzles 395 positioned in the container 31 and connected to the fire sprinkler pipe 394.

In use, the power supply module 34, the water supply module 35, and the air supply module 36 are turned on to provide electricity, water, and compressed air to the molding machines 32. The plastic materials are inputted or transported into the dehumidifiers 332 via the main feeding pipe 331. The dehumidifiers 332 dry the plastic materials, and then the plastic materials are inputted into the molding machines 32. The molding machines 32 mold the plastic materials into products, and transport the products to the product conveyor lines 37 via the first discharge ports 322, and any scrapped products are being carried to the scrap conveyor line 38 via the second discharge ports 323. When the product conveyor lines 37 are transporting the products, the operators can climb to the top of the container 31 by means of the access ladder 381, and walk along the passageway 382 to check on the products.

The molding system 30 integrates the feeding module 33, the power supply module 34, the water supply module 35, and the air supply module 36 in one container 31. Therefore, when any relocation of the molding system 30 is required, the operators only need to separate the container 31, which contains all the essential modules, from the molding machines 32. That is, the molding system 30 can be easily transported and relocated, so that a relocation requires only transporting and installing as opposed to separating, transporting, fitting together and installing. Furthermore, the feeding module 33 and the product conveyor lines 37 are directly connected to the molding machines 32, therefore, any lifting and unloading by hand is avoided.

In alternative embodiments, the number of the receiving boxes 311 of each container 31 may be one, two, three, or more than four.

While the present disclosure has been described with reference to particular embodiments, the description is illustrative of the disclosure and is not to be construed as limiting the disclosure. Therefore, various modifications can be made to the embodiments by those of ordinary skill in the art without departing from the true spirit and scope of the disclosure, as defined by the appended claims.

What is claimed is:

1. A molding system, comprising:
a container; and
a plurality of molding machines positioned adjacent to the container;
wherein the molding system further comprises a feeding module and a power supply module positioned in the container; the feeding module comprises a main feeding pipe, a plurality of dehumidifiers respectively connected to the main feeding pipe, and a plurality of branch feeding pipes connecting the dehumidifiers to the molding machines; the power supply module comprises a power distribution box connected to the molding machines and the dehumidifier.

2. The molding system of claim 1, wherein the molding system further comprises a water supply module positioned on the container, the water supply module comprises a main water pipe and a plurality of branch water pipes connected to the main water pipe, and the branch water pipes are connected to the molding machines.

3. The molding system of claim 2, wherein the container is divided into a plurality of receiving boxes, the main water pipe comprises a first section positioned outside of the receiving box, a second section extending through a side wall of the receiving box, and a third section positioned in the receiving box and connected to the branch water pipes.

4. The molding system of claim 1, wherein the air supply module comprises a main air pipe and a plurality of branch air pipes connected to the main air pipe, the branch air pipes are connected to the molding machines.

5. The molding system of claim 1, wherein each of the plurality of molding machines forms a feeding hopper connected to the branch feeding pipe.

6. The molding system of claim 1, wherein each of the plurality of molding machines forms a first discharge port and a second discharge ports; the molding system further comprises a product conveyor line corresponding to the first discharge ports, and a scrap conveyor line corresponding to the second discharge ports.

7. The molding system of claim 6, wherein an anti-dust cover is positioned over the product conveyor line.

8. The molding system of claim 1, wherein the molding system further comprises a first light source positioned in the container and a second light source positioned on the top of the container.

9. The molding system of claim 1, wherein the molding system further comprises an access ladder positioned on an end of the container.

10. The molding system of claim 1, wherein the molding system further comprises a fire sprinkler pipe and a plurality of sprinkler nozzles positioned in the container and connected to the fire sprinkler pipe.

11. A molding system, comprising:
a container; and
a plurality of molding machines positioned adjacent to the container;
wherein the molding system integrates a feeding module and a power supply module in the container; the feeding module comprises a main feeding pipe, a plurality of dehumidifiers respectively connected to the main feeding pipe, and a plurality of branch feeding pipes connecting the dehumidifiers to the molding machines; the power supply module is configured to supply power to the molding machines and the dehumidifiers.

12. The molding system of claim 11, wherein the molding system further comprises a water supply module positioned on the container, the water supply module comprises a main water pipe and a plurality of branch water pipes connected to the main water pipe, and the branch water pipes are connected to the molding machines.

13. The molding system of claim 12, wherein the container is divided into a plurality of receiving boxes, the main water pipe comprises a first section positioned outside of the receiving box, a second section extending through a side wall of the receiving box, and a third section positioned in the receiving box and connected to the branch water pipes.

14. The molding system of claim 11, wherein the air supply module comprises a main air pipe and a plurality of branch air pipes connected to the main air pipe, the branch air pipes are connected to the molding machines.

15. The molding system of claim 11, wherein each of the plurality of molding machines forms a feeding hopper connected to the branch feeding pipe.

16. The molding system of claim 11, wherein each of the plurality of molding machines forms a first discharge port and a second discharge ports; the molding system further comprises a product conveyor line corresponding to the first discharge ports, and a scrap conveyor line corresponding to the second discharge ports.

17. The molding system of claim 16, wherein an anti-dust cover is positioned over the product conveyor line.

18. The molding system of claim 11, wherein the molding system further comprises a first light source positioned in the container and a second light source positioned on the top of the container.

19. The molding system of claim 11, wherein the molding system further comprises a access ladder positioned on an end of the container.

20. The molding system of claim 11, wherein the molding system further comprises a fire sprinkler pipe and a plurality of sprinkler nozzles positioned in the container and connected to the fire sprinkler pipe.
